(19) United States
(12) Patent Application Publication
(10) Pub. No.: US 2023/0386202 A1
(43) Pub. Date: Nov. 30, 2023

(54) CREATION AND USAGE OF MULTIDIMENSIONAL REALITY CAPTURE

(71) Applicant: Google LLC, Mountain View, CA (US)

(72) Inventors: Nitin Suresh, Sunnyvale, CA (US); Bilawal Singh Sidhu, San Francisco, CA (US)

(21) Appl. No.: 18/245,967

(22) PCT Filed: Sep. 24, 2020
(86) PCT No.: PCT/US20/70575

§ 371 Date: Mar. 20, 2023

(51) Int. Cl. G06V 20/20; G06V 10/771; G06T 7/60; G06T 15/00

(52) U.S. Cl. CPC G06V 20/20; G06V 10/771; G06T 7/60; G06T 15/005

(57) ABSTRACT

A computer-implemented method can include capturing, by one or more of a plurality of sensors of a computing device, respective sensor data corresponding to a physical environment. The method can further include generating by a processor of the computing device from the respective sensor data, a multidimensional dataset representative of the physical environment. The multidimensional dataset can include the respective sensor data, geometric data corresponding with the physical environment, semantic data corresponding with the physical environment. The method can also include identifying and indexing, by the processor of the computing device, a plurality of dimensions of the multidimensional dataset, such that the plurality of dimensions of the multidimensional dataset can be, at least one of, searched, queried, and/or modified to provide, based on the search, query and/or modification, a visualization of the physical environment on a display device.

### BACKGROUND

Augmented reality (AR) frameworks, such as AR frameworks for mobile electronic devices (e.g., smartphones, tablet computers, Internet-enabled glasses, etc.) have become widely available. The availability of such AR frameworks, in combination with advances in sensors (e.g., cameras, depth sensors, light sensors, and so forth) implemented in consumer electronic devices (e.g., mobile devices) has enabled the realistic capture of physical environments and objects (e.g., capture of data that can be used to generate visualizations of the physical environment). Such data capture can be referred to as reality capture; however, current approaches for reality capture are generally directed to producing fixed visualizations (e.g., virtual tours of homes or apartments) and virtual object placement (e.g., furniture placement) in a AR visualization of the physical environment displayed on an electronic device (e.g., a mobile device or other computing device). That is, in current approaches, AR visualizations are typically provided as a textured 3D mesh, and/or as locally isolated panoramas (or photospheres) representative of the corresponding physical environment. Additionally, current approaches for reality capture can require the use of sophisticated equipment (e.g., 360 degree cameras), and associated user sophistication, to accurately capture a physical environment, which can increase complexity and an amount of time required to perform a reality capture.

### SUMMARY

In a general aspect, a computer-implemented method can include capturing, by one or more of a plurality of sensors of a computing device, respective sensor data corresponding to a physical environment. The method can further include generating, by a processor of the computing device from the respective sensor data, a multidimensional dataset representative of the physical environment. The multidimensional dataset can include the respective sensor data, geometric data corresponding with the physical environment, and semantic data corresponding with the physical environment. The method can also include identifying and indexing, by the processor of the computing device, a plurality of dimensions of the multidimensional dataset, such that the plurality of dimensions of the multidimensional dataset can be, at least one of, searched, queried, and/or modified to provide, based on the search, query and/or modification, a visualization of the physical environment on a display device.

Implementations can include one of more of the following features. For instance, the geometric data can be derived from the respective sensor data, and the semantic data can be determined from the geometric data and the respective sensor data. The semantic data can be determined based on features of the physical environment identified by an augmented reality (AR) framework. The AR framework can be implemented by one of the processor of the computing device, or a computing device operatively coupled with the computing device.

The respective sensor data can be first sensor data, and the method can include capturing second sensor data corresponding to the physical environment, and modifying, based on the second sensor data, the multidimensional dataset. Capturing the second sensor data can include providing capturing guidance, via the computing device. The capturing guidance can be based on the multidimensional dataset. The geometric data can be first geometric data, the sematic data can be first semantic data, and the modifying the multidimensional dataset can include adding the second sensor data to the multidimensional dataset, adding second geometric data corresponding with the physical environment to the multidimensional dataset, and adding second semantic data corresponding with the physical environment to the multidimensional dataset.

Modifying the multidimensional dataset can include, at least one of, determining differences between the first sensor data and the second sensor data; determining differences between the first geometric data and the second geometric data, or determining differences between the first semantic data and the second semantic data. Modifying the multidimensional dataset can include aggregating the second sensor data with the first sensor data to produce aggregated sensor data, modifying the geometric data based on the aggregated sensor data, and modifying the semantic data based on the aggregated sensor data and the modified geometric data. Capturing the second sensor data can include capturing the second sensor data with one or more of the plurality of sensors of the computing device.

The computing device can be a first computing device. The capturing the second sensor data can include capturing respective sensor data for a plurality of sensors of a second computing device.

The plurality of dimensions can include one or more of lighting of the physical environment, objects in the physical environment, a time corresponding with capturing the respective sensor data, regions of the physical environment, physical dimensions of the physical environment, or surfaces in the physical environment. The plurality of sensors can include one or more of an image sensor, a depth sensor, a location sensor, an orientation sensor, a motion sensor, a light sensor, a pressure sensor, or a temperature sensor.

The method can include receiving, at the computing device or another computing device, a visualization request including a query identifying a dimension of the plurality of dimensions of the multidimensional dataset, and providing, on a display device of the computing device or the other computing device, a visualization based on the multidimensional dataset and the query.

In another general aspect, a computing device can include a plurality of sensors, a processor, and a memory having instructions stored therein. The instructions, when executed by the processor, can result in capturing, by one or more of the plurality of sensors of the computing device, respective sensor data corresponding to a physical environment, and generating, by the processor of the computing device from the respective sensor data, a multidimensional dataset representative of the physical environment. The multidimensional dataset can include the respective sensor data, geometric data corresponding with the physical environment, and semantic data corresponding with the physical environment. The instructions, when executed, can further result in identifying and indexing, by the processor of the computing device, a plurality of dimensions of the multidimensional dataset, such that the plurality of dimensions of the multidimensional dataset can be, at least one of, searched, queried, and/or modified to provide, based on the search, query and/or modification, a visualization of the physical environment on a display device.

Implementations can include one or more of the following features. For example, the respective sensor data can be first sensor data, and the instructions, when executed by the processor, can further result in capturing second sensor data corresponding to the physical environment, and modifying, based on the second sensor data, the multidimensional dataset. Capturing the second sensor data can include providing capturing guidance, via the computing device, the capturing guidance being based on the multidimensional dataset.

In another general aspect, a non-transitory computer-readable medium can have instructions stored thereon. The instructions, when executed by a processor of the computing device, can result in the computing device capturing, by one or more of a plurality of sensors of a computing device, respective sensor data corresponding to a physical environment, and generating, from the respective sensor data, a multidimensional dataset representative of the physical environment. The multidimensional dataset can include the respective sensor data, geometric data corresponding with the physical environment, and semantic data corresponding with the physical environment. The instructions, when executed, can further result in identifying and indexing a plurality of dimensions of the multidimensional dataset, such that the plurality of dimensions of the multidimensional dataset can be, at least one of, searched, queried, and/or modified to provide, based on the search, query and/or modification, a visualization of the physical environment on a display device.

Implementations can include one or more of the following features. For example, the respective sensor data can be first sensor data. The instructions, when executed by the processor, can further result in the computing device capturing second sensor data corresponding to the physical environment, and modifying, based on the second sensor data, the multidimensional dataset. The instructions, when executed by the processor, can further result in the computing device receiving, at the computing device or another computing device, a visualization request including a query identifying a dimension of the plurality of dimensions of the multidimensional dataset, and providing, on a display device of the computing device or the other computing device, a visualization based on the multidimensional dataset and the query.

### BRIEF DESCRIPTION OF THE DRAWINGS

FIG. 1 is a block diagram that schematically illustrates a system for multidimensional reality capture and usage (e.g., viewing and analysis).

FIG. 2 is a block diagram that schematically illustrates generation, updating and usage (e.g., viewing and analysis) of a multidimensional reality capture.

FIG. 3 is a diagram illustrating a multidimensional scene set.

FIG. 4 is a flowchart illustrating a method for creation and/or usage of a multidimensional reality capture scene set.

FIGS. 5A and 5B are diagrams that illustrate reality capture approaches for a multidimensional scene set.

FIG. 6 is a diagram that illustrates reality capture of an object.

FIG. 7 is a diagram that illustrates generation of a multidimensional scene set using reality captures from multiple devices.

FIG. 8 is a diagram that illustrates usage of a multidimensional scene set.

FIGS. 9A-9C are diagrams that illustrate creations and usage of another multidimensional scene set.

FIG. 10 is a diagram that illustrates usage of another multidimensional scene set.

FIG. 11 is a diagram that schematically illustrates generation of a multidimensional scene set using multiple reality captures.

FIG. 12A-12C are a series of diagrams that illustrate generation of a multidimensional scene set.

FIG. 13 shows an example of a computing device and a mobile computing device, which can be used to implement the techniques described herein.

### DETAILED DESCRIPTION

This disclosure is directed to approaches for reality capture of physical environments and corresponding visualizations, where data for generating visualizations of a corresponding physical environment (e.g., on a display of a computing device) can be included in a multidimensional dataset (multidimensional scene set). Using the approaches described herein, such a multidimensional dataset can be based on data (e.g., sensor data) captured in the physical environment from a single data capture, or multiple data captures (using a single capture device or multiple capture devices). Aspects (dimensions, etc.) of the multidimensional dataset can then be identified and indexed, such that the multidimensional dataset can be queried, and a visualization of the physical environment can be provided based on the multidimensional dataset and the query. For purposes of this disclosure, dimensions of a multidimensional dataset can include various attributes of the corresponding physical environment, such as objects in the physical environment, location of those objects, location of walls, location of windows, distances between elements of the physical environment, a time of data capture, lighting of the physical environment, etc.

As used herein, a multidimensional dataset refers to a n-dimensional data structure (where n represents a number of dimensions of the dataset). Such a multidimensional dataset can represents a plurality of observations representing a real world physical environment. These observations can be indexed as dimensions and included in, for example, database records, such as described herein, such that they can be indexed, queried, filtered, etc. Such observations can include, but are not limited to sensor data, geometry data and semantic data, which can be collected over (or can represent) physical space and time. As used herein, sensor data can refer to values from image and non-image based sensors such as digital cameras (e.g., cameras including a charge-coupled device sensor, a complimentary metal-oxide semiconductor sensor, etc.), depth cameras (e.g., time-of-flight, light distancing and ranging (LiDAR), motion stereo), location sensors (e.g., global positioning system, global navigation satellite system, real-time kinetic positioning), radio sensors (cell towers, WiFi etc.) inertial sensors (inertial measurement unit, etc.), magnetometers, barometers, and so forth. In example implementations, sensor data can be collected by a device that samples real-world phenomenon at a fixed point in time, or over a period of time. As used herein, geometric data refers to data that provides an understanding (e.g., an implicit or explicit definition) of the structure, shape and appearance of physical spaces and objects therein. Such geometric data can be generated (derived) from sensor data using, e.g., photogrammetric approaches, ML-based computer vision algorithms, and so forth, to produce measures such as depth, volume, shape, texture, pose, disparity, motion, flow etc. These measures (geometric data) can be stable in time, or can be time varying. As used herein, semantic data refers to data that can ascribe implementation dependent meaning to sensor and/or geometric data, or to aggregations of sensor and/or geometric data. Such semantic data can be generated using a plurality of techniques to represent identity, segmentation, classification, and attributes of objects and the scene. A plurality of such classes can be described by an appropriate probability distribution. As with geometric data, semantic data can be stable in time, or can be time varying.

In some implementations, multiple data captures of a physical environment and/or object can be performed, and sensor data from those multiple captures can be included in a corresponding multidimensional dataset. That is, a multidimensional dataset can be added to, refined, modified, etc., based on multiple captures, which can improve an understanding to the corresponding physical environment and/or an object (e.g., objects within a physical environment). That is, multiple reality captures can be performed and a corresponding multidimensional dataset can be modified (refined, improved, etc.) based on sensor data from each subsequent data capture. Depending on the particular situation, data from multiple data captures can be appended together, or can be aggregated (combined, etc.), which can include modifying or replacing data from previous captures. For instance, if a sensor (e.g., a depth sensor) used in a subsequent data capture is more accurate than a sensor used in a previous data capture, dimensions of a corresponding multidimensional dataset can be aggregated, or updated (replaced, revised, etc.). In other instances, additional dimensions can be added (e.g., based on changes in the physical environment), or additional details can be added to an existing dimension (e.g., a new light source, a different lighting direction, a new object, changes in the physical environment, etc.).

Further, in some implementations, such as those described herein, guidance for capture or collection of sensor data for inclusion in a corresponding multidimensional dataset can be provided to a user (e.g., via text prompts, audio prompts, etc.) on a computing device (e.g., mobile device) that is performing the sensor data capture. Such guidance can be provided based on an understanding of the corresponding physical environment obtained from previous data collections (collections, captures, etc.). Such guidance can simplify, as well as improve the sensor data collection process. Such guidance can be based, at least in part, on user actions (movement, pauses, swivels) during collection of sensor data, from which an intent to capture a specific feature or object (e.g., dimension) of a physical environment can be inferred. For instance, if a user performs a swivel (e.g. a 360 rotation, either outside-in or inside-out) during collection of sensor data, or pauses while moving through a physical environment, the approaches described herein can infer that the region or object being scanned is of interest, and can provide corresponding guidance during subsequent data captures of that physical environment (e.g., to capture additional sensor data for that region or object). In some implementations, other types of guidance can be provided (e.g., based on previous captures), such as move closer to an object, move away from the wall, move further or closer to the window to improve image exposure, etc. For instance, such guidance can be provided based on previously obtained sensor data, geometric data and/or semantic, such described herein.

The implementations described herein can provide a number of advantages over current approaches for providing fixed visualizations. For instance, the example implementations described herein can provide for capturing, indexing and then querying reality captures across an arbitrary number of dimensions. These capabilities, as well as other advantages can be achieved, at least in part, through the use of multidimensional datasets, where multiple reality captures can be performed on a physical environment (e.g., by multiple users, by multiple devices, at different times, at different vantage points, etc.). These multiple reality captures can then be used to build and maintain (refine, evolve, etc.) an understanding (n-dimensional) understanding of the corresponding physical environment (e.g., a scene). Further, in the implementations described herein, intent of a user performing a reality capture can be inferred (e.g., intent to scan an object of interest). That inferred intent, as well as other information in a multidimensional data set, can be used to provide guidance to a user during a reality capture. Additionally, the disclosed approaches allow for querying (filtering, analyzing, etc.) scenes across the dimensional of a multidimensional data set, where the dimensions can include, but are not limited to objects of interest, lighting conditions, time of capture, and/or regions of interest.

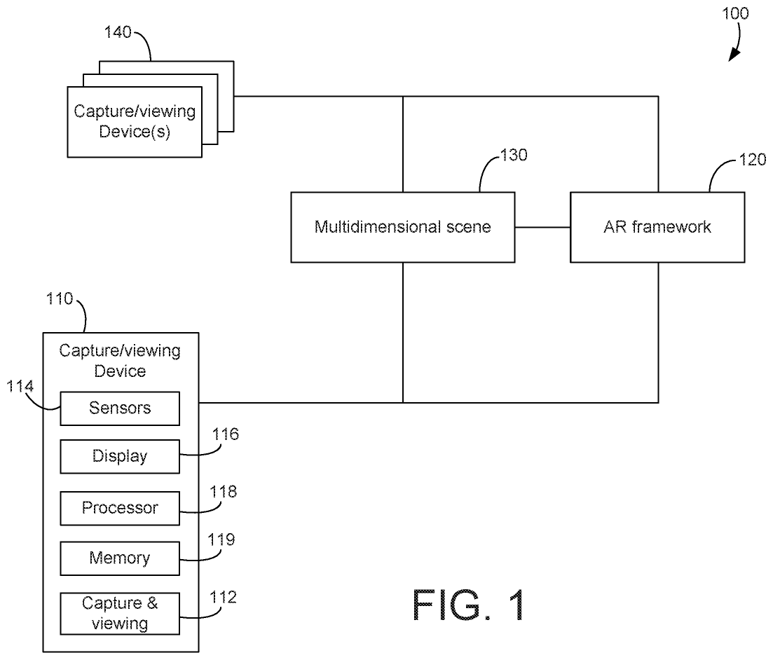

FIG. 1 is a block diagram that schematically illustrates a system 100 for multidimensional reality capture and usage (e.g., viewing and analysis). The system 100 is provided and described by way of example and for purposes of illustration. In some implementations, the system 100 can be implemented in a single computing device, such as a mobile computing device (e.g., a smartphone, a tablet computer, Internet-enabled glasses, etc.). In some implementations, other arrangements of the system 100 are possible.

As shown in FIG. 1, the system 100 includes a device 110 (a capture/viewing device), an AR framework 120, a multidimensional scene, and additional devices 140 (additional capture/viewing devices). In some implementations, the multidimensional scene 130 can include information collected in multiple captures performed using the device 110 and/or the additional devices 140. As shown in FIG. 1, the device 110 can include an application 112 (a capture and viewing application), sensors 114 (for gathering sensor data corresponding to a physical environment), a display 116, a processor 118 and a memory 119. While not shown, the additional devices 140 can include similar elements as the device 110. Accordingly, the discussion of the operation of the device 110 can apply equally to operation of the additional devices 140.

In some implementations, the application 112 can be implemented as machine-readable instructions stored in the memory 119 that, when executed by the processor 118, cause the device 110 (or the additional devices 140) to implement the approaches described herein. In this example, the application 112 can work in conjunction with the AR framework 120 to generate the multidimensional scene 130. The application 112 can allow for analyzing dimensions of the multidimensional scene 130 and providing (rendering, etc.) a corresponding visualization of a physical environment, where the visualization can be based on the analysis of the multidimensional scene 130. In particular, the application 112 can also allow for searching, querying and/or modifying dimensions of the multidimensional scene 130 and providing (rendering, etc.) a corresponding visualization of a physical environment, where the visualization can be based on a search or query of the multidimensional scene 130. Examples of such implementations and example use cases are described in further detail below.

In the example system 100, the AR framework 120 can work in conjunction with the device 110 (and the additional devices 140) to generate and maintain the multidimensional scene 130. For instance, the application 112 and the AR framework 120 can, based on data collected by the device 110 using the sensors 114, identify dimensions of a corresponding physical environment. That is, the application 112 and/or the AR framework 120 can generate (derive from sensor data) geometric data for the physical environment, such as the shape of the physical environment, shapes of objects within the physical environment, distances, relative locations of elements in the physical environment, etc. Also, using machine-implemented photogrammetric techniques, the application 112 and/or the AR framework 120 can identify objects in the physical environment. In some implementations, semantic data, such as described herein, can then be generated, e.g., by the application 112 and/or the AR framework 120, from the sensor data, the derived geometric data and/or identification of objects achieved using photogrammetric techniques. Such semantic data, in combination with the geometric data, can provide a real world understanding of the physical environment, as represented by the captured sensor data.

In some implementations, such as the system 100, the AR framework 120 can, either during collection of sensor data or using sensor data post-collection, track or determine motion (position and orientation) of the device 110 (or the additional devices 140) associated with collected sensor data. This tracking can provide or enable environmental understanding, light estimation, object identification, etc. for a corresponding physical environment. That is, such tracking (motion tracking) can provide a real world understanding of the device's position (and orientation) relative to the elements (dimensions) of the corresponding physical environment. This understanding can allow for detection (determination) of the size and location of all types of surfaces, e.g., horizontal, vertical, and angled surfaces, etc. Further, light estimation can allow for understanding lighting (brightness, light source location, light source, etc.) of the physical environment's lighting conditions during capture of the corresponding sensor data.

For instance, the AR framework 120 can track or determine the position of a device (e.g., a mobile device), such as the device 110, as its moves (or moved) through the physical environment capturing sensor data, which allows the device 110 (e.g., using the application 112) to build its own understanding of the real world. This understanding can be included in (represented by) a dataset of the multidimensional scene 130. In such implementations, the application 112 and the AR framework 120 can use the sensors 114, or data from the sensors 114 (e.g., camera, depth sensor, accelerometer, gyroscope, inertial measurement unit (IMU), global positioning system (GPS), etc.) to identify interesting points (e.g., key points, features, dimensions, etc.) and track how the device 110 moves (or moved) relative to such points over time. In other words, the application 112 and the AR framework 120 may determine position, orientation, etc. of the device 110 as the device moves (or moved) through the real world (physical environment), including pauses and/or swivels, based on a combination of the movement of these points and readings from the sensors 114.

In addition to identifying dimensions of the multidimensional scene 130 discussed above, the application 112 and the AR framework 120 may detect flat surfaces (e.g., table, floor, walls, ceilings, etc.) and may also estimate the average lighting in the surrounding areas (or environment), as well as estimate reflectance of surfaces, texture of surfaces, etc. These capabilities may combine to enable the application 112 and the AR framework 120 to build an understanding of the physical environment that can be stored as data in the multidimensional scene 130. Further, this real world understanding can allow the application 112 to let a user place objects, annotations, or other information in a visualization of a corresponding physical environment based on the AR framework 120. Further, the real world understanding of the multidimensional scene 130 can allow a user to (e.g., in a visualization generated by application 112) to move around and view objects or other aspects of a corresponding physical environment from any angle. As described herein, such visualizations can be provided based on a user query on the multidimensional scene 130, which can be implemented as a database in some implementations.

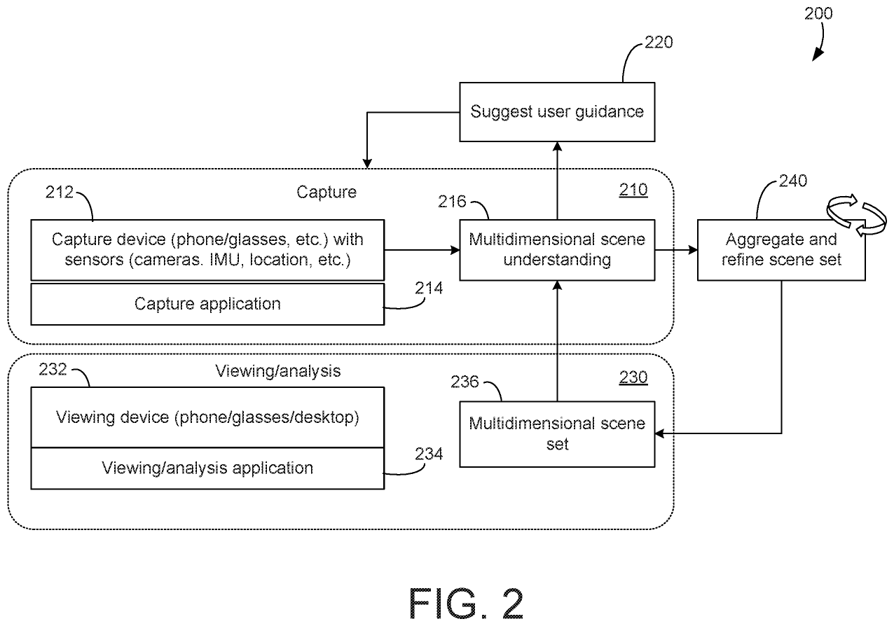

FIG. 2 is a block diagram that schematically illustrates a process 200 for generation, updating and usage (e.g., viewing and analysis) of a multidimensional scene. In some implementations, the process 200 can be implemented using an AR framework, such as the AR framework 120 discussed above with respect to FIG. 1. That is, in some implementations, the process 200 can be implemented in the system 100, though it can also be implemented in other systems or devices.

As shown in FIG. 2, the process 200 includes a capture block (block 210), a user guidance block (block 220), a viewing and analysis block (block 230), and an aggregation and refinement block (block 240). Example operational relationships between these blocks are shown in FIG. 2, and are discussed further below.

As shown in FIG. 2, the block 210 includes a capture device 212 (mobile phone, Internet-enabled glasses, etc.) with sensors (camera, IMU, location, etc.) that executes a capture application 214. As shown in FIG. 2, the capture device 212 can, using the sensors of the capture device 212 and the capture application 214 (e.g., in conjunction with an AR framework), build a multidimensional scene understanding 216 of a physical environment. The block 220 can, e.g., based on the multidimensional scene understanding 216, provide guidance to a user of the capture device 212 for collection of sensor data corresponding to the physical environment. This guidance can be based on the multidimensional scene understanding 216 developed during an initial reality capture, and/or can be based on aspects of the multidimensional scene understanding 216 from one or more previous reality captures.

In the example process 200 of FIG. 2, the multidimensional scene understanding 216 can be provided to the block 240, which can generate, refine, aggregate information (data) from the multidimensional scene understanding 216 (e.g., based on a current reality capture) in a multidimensional scene set 236. The multidimensional scene set 236 can then be provided to the block 230 for querying, analysis and generation of associated visualizations. Depending on the particular situation, the block 240 can create a new multidimensional scene set (e.g., if data from a previous reality capture for a given physical environment is not available), or can update (aggregate, refine, modify, etc.) an existing multidimensional scene set for a corresponding physical environment.

As shown in FIG. 2, in the process 200, the block 230 includes a viewing device 232 (mobile phone, Internet-enabled glasses, desktop computer, etc.) that executes a viewing application 234 (a viewing/analysis application). While the capture application 214 and the viewing application 234 are shown separately in FIG. 2, in some implementations they can be co-implemented in a single application, such as the application 112 in FIG. 1. As described herein, the viewing application 234 can provide (render, etc.) visualizations of a physical environment based on a query on the multidimensional scene set 236. Examples, of such queries are discussed further below.

As discussed with respect to the multidimensional scene 130 of the system 100, developing the multidimensional scene understanding 216 in the process 200 can involve developing an understanding of the sensor data collected, and its correspondence to a physical environment. For instance, such understanding can be based on position and orientation of the capture device 212 when capturing sensor data. The multidimensional scene understanding 216 can also be based on determining various real world attributes of the physical environment, including locations of planes, locations of objects, depth maps, lighting info, etc. This is allows the multidimensional scene understanding 216 to be used, e.g., at block 220, to guide a user for a better reality capture experience, and/or for detecting (inferring) user intent in reality captures (e.g., from analyzing captured sensor data).

Similarly as discussed above with respect to the system 100, the multidimensional scene understanding 216 in the process 200 can be achieved using an AR framework (e.g., the AR framework 120) in conjunction with the capture application 214, on either live or previously captured sensor data. That is, the multidimensional scene understanding 216 can be achieved based on real time sensor data (during collection), or post-processed (previously captured) sensor data. Depending on the particular implementation, sensor data can be processed on the capture device 212, and/or on a remote computing device, such as a cloud server.

The sensors used for a reality capture will depend on a particular implementation of the capture device 212. Such sensors can include one or more of camera(s), an IMU (e.g., gyroscope, accelerometer, etc.), a depth sensor (stereo motion, time-of-flight, LiDAR, etc.), a location sensor (e.g., GPS, WiFi, cellular, etc.), as well as a number of sensors (e.g., a step meter, a light sensor, a pressure sensor, a temperature sensor, a clock, etc.). In some implementations, data from multiple sensors can be combined (fused, aggregated, etc.), which can improve the quality of an associated reality capture.

In the approaches described herein, the use of an AR framework can allow for detailed identification (extraction) of features (e.g. dimensions of a multidimensional scene set) from available sensor data. This detailed identification of features can, in turn, allow the capture device 212 (e.g., the capture application 214) to develop an accurate real world understanding of a corresponding physical environment. These features can be continuously or repeatedly extracted (e.g., from multiple reality captures) and those extracted features can be used to update (aggregate, modify, etc.) the multidimensional scene understanding 216.

As some examples, the following features can be determined (extracted) from sensor data collected by the capture device 212. Pose can indicate where a camera is, and which direction it is pointing (e.g., a 6-degrees-of-freedom (DoF) position). Camera images, in combination with pose, can provide an understanding of what a physical environment looks like from a specific location and direction of gaze. Camera image metadata can provide information, such as lens focal distance and camera exposure. Depth images, in combination with pose, camera images and depth maps, can provide an understanding of a 3-dimensional (3D) view of an object at a particular location, and vice versa, which can enable searching for objects (e.g., using a particular object as a dimension of the multidimensional scene understanding 216). Other features that can be extract from collected sensor data are light estimate, which can provide an understanding of scene lighting information for a given image frame; real world geometry surfaces, such as tabletops, walls, etc.; surface normals; and reflectance estimates. These features are provided by way of example. In some implementations, other features can be extracted, certain features may not extracted, or alternative features can be extracted. Using such extracted features, the capture device 212 can understand, for a physical environment, the shape of objects, distances to walls and floors, places with the best lighting, which frames have the best image quality, etc., and include that understanding in the multidimensional scene understanding 216, and/or use that understanding to provide guidance to a user collecting sensor data for the physical environment with the capture device 212.

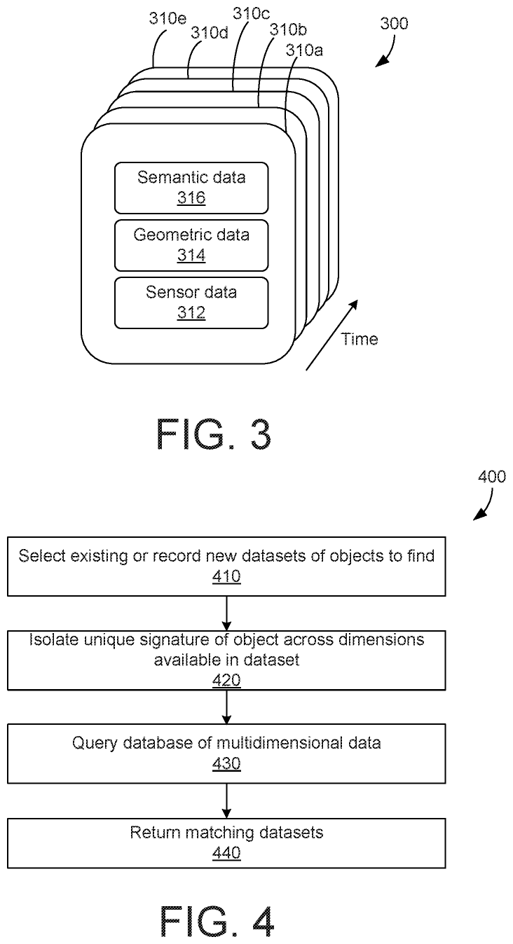

FIG. 3 is a diagram illustrating an implementation of a multidimensional scene set 300. In this example, data for the multidimensional scene set 300 can be included in database records 310a, 310b, 310c, 310d and 310e, where each of the database records 310a-310e corresponds with a respective reality capture (collection of sensor data). The data included in each database record can vary depending on the particular implementation. In this example, each database record 310a-310e can include data as discussed with respect to FIG. 1. Accordingly, the approaches described with respect to FIG. 1 can be equally applied to the example of FIG. 3.

As shown in FIG. 3, the database record 310a includes sensor data 312 (which can be raw sensor data), geometric data 314 (which can be derived from the sensor data 312), and semantic data 316 (which can be data determined by a capture application and/or an AR framework) that provides a real world understanding of the sensor data 312 and the geometric data 314. As discussed above, s used herein, sensor data can refer to values from image and non-image based sensors such as digital cameras (e.g., cameras including a charge-coupled device sensor, a complimentary metal-oxide semiconductor sensor, etc.), depth cameras (e.g., time-of-flight, light distancing and ranging (LiDAR), motion stereo), location sensors (e.g., global positioning system, global navigation satellite system, real-time kinetic positioning), radio sensors (cell towers, WiFi etc.) inertial sensors (inertial measurement unit, etc.), magnetometers, barometers, and so forth. In example implementations, sensor data can be collected by a device that samples real-world phenomenon at a fixed point in time, or over a period of time. As used herein, geometric data refers to data that provides an understanding (e.g., an implicit or explicit definition) of the structure, shape and appearance of physical spaces and objects therein. Such geometric data can be generated (derived) from sensor data using, e.g., photogrammetric approaches, machine-learning-based computer vision algorithms, and so forth, to produce measures such as depth, volume, shape, texture, pose, disparity, motion, flow etc. These measures (geometric data) can be stable in time, or can be time varying. As used herein, semantic data refers to data that can ascribe implementation dependent meaning to sensor and/or geometric data, or to aggregations of sensor and/or geometric data. Such semantic data can be generated using a plurality of techniques to represent identity, segmentation, classification, and attributes of objects and the scene. A plurality of such classes can be described by an appropriate probability distribution. As with geometric data, semantic data can be stable in time, or can be time varying.

As also shown in FIG. 3, in this example implementation, the database records 310a-310e can be organized based on a time of reality capture. In this example, the multidimensional scene set 300 can then be queried based on time (as one of a plurality of dimensions of the multidimensional scene set 300, and a corresponding time filtered visualization, based on the multidimensional scene set 300 and the query, can be provided. As discussed herein, data in the database records 310a-310e of the multidimensional scene set 300 can be appended, aggregated, fused, modified, replace, removed, etc., based on changes in an understanding of the physical environment resulting from multiple reality captures, such as time-subsequent reality captures. As discussed herein, the respective reality captures corresponding with the database records 310a-310e can be performed using a same capture device, or can be performed using two or more different capture devices.

FIG. 4 is a flowchart illustrating a method 400 for creation and/or usage of a multidimensional (reality capture) scene set. The method 400 can be implemented using the approaches described herein. Accordingly, for purposes of brevity, those approaches will not be described again in detail with respect to FIG. 4.

At block 410, the method 400 includes selecting an existing multidimensional scene set (e.g., for a second or later reality capture of a corresponding physical environment), or recording (creating, opening, etc.) a new multidimensional scene set (e.g., for an initial reality capture of a physical environment). At block 420, the method 400 includes identifying and isolating unique signatures of objects across available dimensions in the existing or new multidimensional scene set. This can include indexing the multidimensional scene set, such as described herein. At 430, the method 400 includes querying a database of the multidimensional scene set (e.g., specifying a dimension of interest). At block 440, the method 400 includes returning matching datasets of the multidimensional scene set, which can include providing a corresponding visualization.

The method 400, as illustrated in FIG. 4, can enable 3D object search (where the specific object is indexed as a dimension of a corresponding multidimensional scene set). For instance, a user could scan 3D objects in their physical environment or obtain such a 3D object from elsewhere, and then search for it or place it as desired in a visualization of the physical environment, where the visualization is provided based on a corresponding multidimensional scene set. Such approaches could also allow users to utilize a multidimensional scene set to provide visualizations based on natural language queries, such as “Search for the best spot in the house to hang a picture”, “Auto arrange furniture in the dining room”, or “Show me power tools in the garage”, as some examples.

For instance, in the example of searching for a spot to hang a picture, a multidimensional data set (e.g., geometric and semantic data) can be analyzed to identify vertical planes (e.g., walls) in a corresponding physical environment (e.g., a house). After identifying walls (vertical planes), open areas of the wall could then be identified, such as based on texture, uniform color, patterns, etc., to identify possible locations for hanging a painting. Dimensions of the painting, along with other dimensional criteria, such as distance from floor, distance from other objects, such as other walls, etc. could be applied to statistically rank the identified open areas on the wall, and a visualization could be provided show the location (or multiple locations) that best match the applied criteria. A similar process could be implemented for furniture placement, e.g., based on furniture to be placed, an understanding of the physical environment from the multidimensional data set, a set of object criteria for furniture place (e.g., distances, don't put a table next to a table, etc.). The example of showing power tools in the garage can be accomplished, e.g., by applying computer vision analysis to objects (indexed as dimensions of a multidimensional dataset) and providing a visualization that show indexed objects that are identified as power tools.

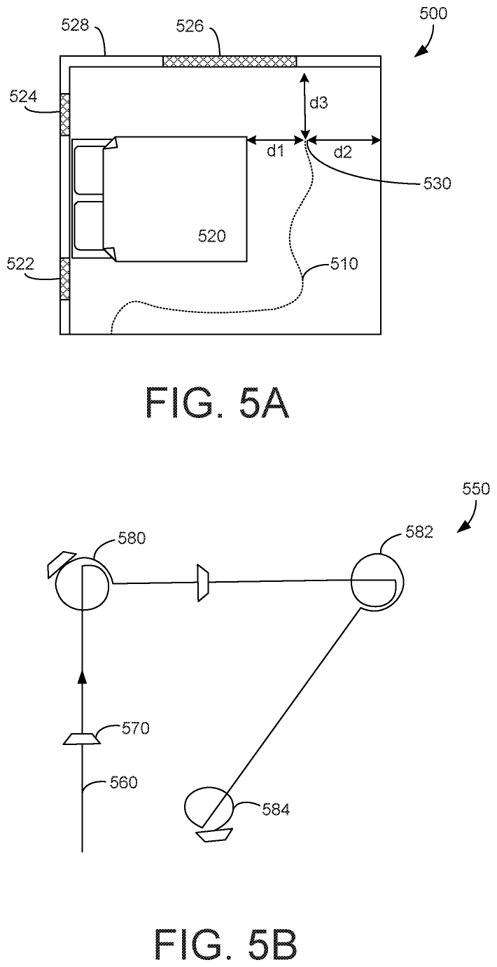

FIGS. 5A and 5B are diagrams that illustrate reality capture approaches for a multidimensional scene set. FIG. 5A schematically illustrates performance of a reality capture of a physical environment 500, a bedroom in this example. The physical environment 500, as shown in FIG. 5A illustrates a user path 510, a bed 520, windows 522, 524, and 526, and walls 528 As shown in FIG. 5A, a user can move through the physical environment 500 along the path 510 (which can be captured by a capture device's sensors as a 6 DoF path) while collecting sensor data on the capture device. That sensor data can then be used to create, or add to a multidimensional scene understanding that is included in a multidimensional scene dataset. Also shown in FIG. 5A are dimensions d1, d2 and d3 that can be derived from collected sensor data (e.g., from a prior reality capture) and included in a corresponding multidimensional scene set (e.g., a database). These dimensions d1-d3 could be used to provide guidance to the user during the reality capture. For instance, if the user get closer than the distance d3 to the window 526, a capture application being used to collect sensor data could suggest that the user move away from the window 526 to prevent overexposure of the image frames. Likewise if the user gets closer than the distance d1 to the bed 520, the capture application could suggest that the user move away from the bed 520.

FIG. 5B schematically illustrates performance of a reality capture of a physical environment 550, an arbitrary physical environment in this example. FIG. 5B illustrates an example of how user intent can be interpreted from collected sensor data. In the example of FIG. 5B, a user can move along a path 560, collecting sensor data (e.g., 6 DoF sensor data) for the physical environment 550. As the user moves along the path 560, in this example, the user performs swivels 580, 582 and 584 (e.g., inside-out, 360 degree rotations). These points along the path can be inferred, e.g., by a capture application, as points of interest in the physical environment 550. These points then be indexed, so that they are searchable (are dimensions) in a corresponding multidimensional scene set. In the examples of FIGS. 5A and 5B, user guidance for capturing (collecting) sensor data can be provided based on previously reality captures of the respective physical environments 500 and 550.

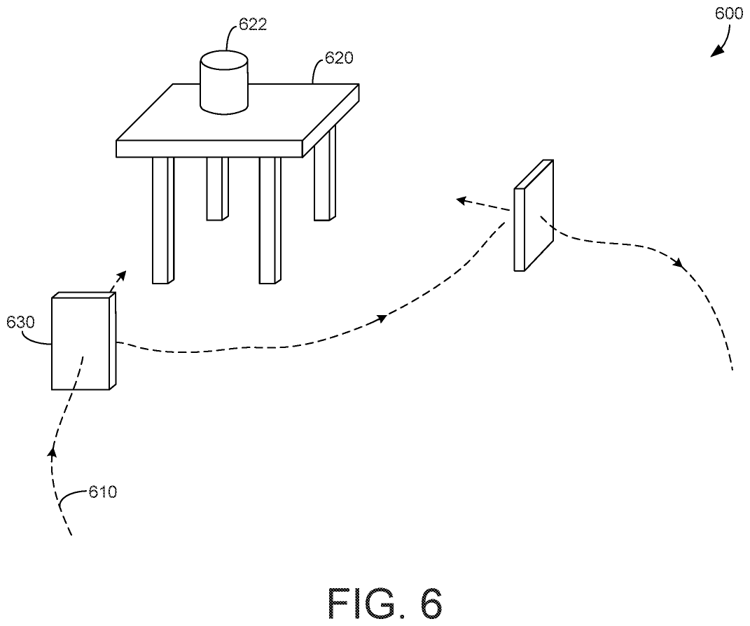

FIG. 6 is a diagram that illustrates reality capture of an object in a physical environment 600. FIG. 6 illustrates an example of how user intent to scan (collect sensor data for) an object can be inferred, e.g., by a capture application. Similar to the examples of FIGS. 5A and 5B, in FIG. 6, a user can move along a path 610 with a camera of a capture device facing toward a table 620. As shown in FIG. 6, the user performs an arced scan of the object 622 on the table 620. As result of the time spent scanning the object 622, it can be inferred, e.g., by a capture application, to be an object of interest in the physical environment 600. The object 622 can then be indexed, so that it is searchable (is a dimension) in a corresponding multidimensional scene set. Further, the capture application could also provide user guidance (e.g., during the current or subsequent sensor data collections) to further scan the object 622 (e.g., perform a 360 degree scan and top side scan, to improve the accuracy of a corresponding 3D model of the object 622).

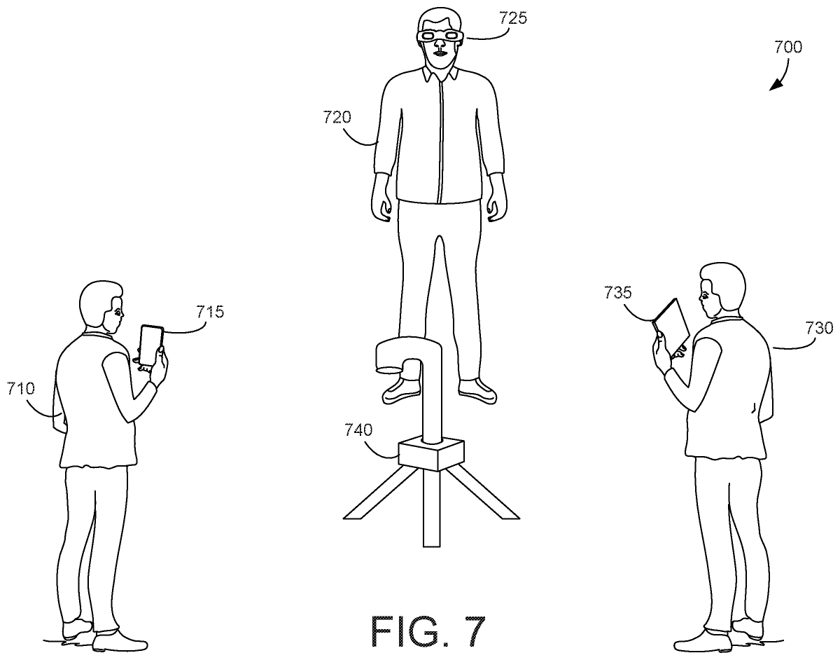

FIG. 7 is a diagram that schematically illustrates generation of a multidimensional scene set using reality captures from multiple devices. FIG. 7 is an example of a use of multidimensional scene sets in a practical application, such as for use in performing routine field inspections in a physical environment 700 (e.g., a factory or other setting). In the example, of FIG. 7, users 710, 720 and 730 can perform a reality capture of a valve 740 using different, respective capture devices 715, 725 and 730. In this example, the capture device 715 can be a mobile phone, which can collect a depth map of the valve 740 using motion stereo. The capture device 725 can be Internet-enabled glasses, which can collect a depth map of the value 740 using Lidar. The capture device 735 can be a tablet computer, which can collect a depth map of the valve 740 using a time-of-flight (ToF) sensor.

Though all of the users 710, 720 and 730 are shown in FIG. 7, each of the users 710, 720 and 730 can collect sensor data at different times, such as on scheduled inspection dates. The collected sensor data can then be used to create and update a multidimensional scene understanding of the valve 740. For instance, deterioration of the valve over time can be identified using a viewing/analysis program, such as those described herein. In this example, a multidimensional scene set corresponding to the routine inspections of the valve can be queried (e.g., using the valve 740 as a dimension, changes in the valve 740 as dimension, etc.) and an appropriate visualization can be provided to closely examine the valve 740 and determine a proper maintenance course to address any degradation.

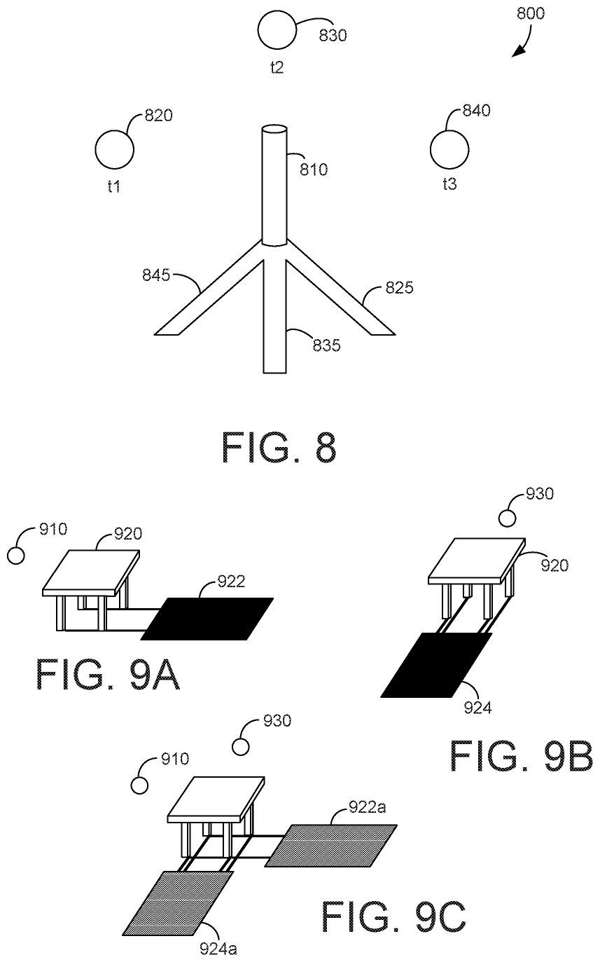

FIG. 8 is a diagram that illustrates usage of a multidimensional scene set for a physical environment 800. In FIG. 8, an object 810 in the physical environment 800 is shown at three different times t1, t2 and t3 with different lighting conditions (e.g., lighting locations) at each of these times. For instance, at time t1, the light source is 820, at time t2, the light source is 830, and at time t3, the light source is 830. As also shown in FIG. 8, a respective shadow 825, 835 and 845 for each of the light sources (light source locations) 820, 830 and 840. A multidimensional understanding of the physical environment 800 can be included in a corresponding multidimensional data set, such as based on respective reality captures performed at times t1, t2 and t3. For example, the corresponding multidimensional data set, in this example, could include, at least, a time dimension, space dimensions, orientation dimensions, and/or light source dimensions. For instance, the time dimension could be time in seconds, time of day, etc. The space dimensions could be x, y and z dimensions of the physical environment 800 and the object 810. The light source dimensions could include light angle, light intensity, light direction, etc., for each of the light sources 810, 820 and 830 and the respective directions (angles, etc.) of the shadow 825, 835, 845.

Based on the corresponding multidimensional data set, visualizations of the physical environment 800 can be provided, e.g., in response to a query (e.g., a requested visualization). For instance, a query can include (define, etc.) a request to view (visualize) the physical environment 800 for a particular set of parameters (dimensions) of the multidimensional dataset, e.g., view at a particular time, view from a particular location, view with a particular light source (or light sources), etc. Depending on the data in the multidimensional dataset and the particular query, providing such a visualization can include aggregating dimension data of the multidimensional data set, as is discussed further below.

As an example of a possible visualization of the physical environment 800, a query could be requested that reduces the number of dimensions (e.g., removes a dimension). For instance, a visualization of the physical environment 800 could be requested (e.g., in a query) that removes one of the dimensions. In an example implementation, removing a dimension of a multidimensional dataset can be achieved by aggregating available values for a particular dimension. For instance, data for the light sources 810, 820 and 820 of the multidimensional dataset for the physical environment 800 can be aggregated, which would allow for producing visualizations with different lighting arrangement than those specifically represented by the corresponding reality captures, including interpolating the location of a shadow (or shadows) based on data (geometric and/or semantic data) associated with the shadows 825, 835 and 845.

As used herein, aggregation refers to operations or sets of operations used to combine information in a multidimensional dataset. For instance, aggregation operations can be used to combine N data (for example, N numerical values) into a single datum. For instance, aggregation can include, e.g., determining arithmetic means, weighted means, etc. In some implementations, aggregation can be performed across a plurality of dimensions of a n-dimensional dataset. That is, aggregation, as used herein, refers to combining different data observations (e.g., for a dimension or dimensions of a multidimensional dataset) to a single data point. As an example, image frames included in a multidimensional data set that are taken from a specific vantage point and angle can be aggregated by computing an average of those frames (and/or for each light source of those frames), and then computing an average of the frames for each pixel.

FIGS. 9A-9C are diagrams that illustrate creation and usage of another multidimensional scene set. Specifically, FIG. 9A-9C illustrate an example of aggregating a dimension of a multidimensional scene set, in this case, lighting of an object in a physical environment 900. Referring to FIG. 9A, in this example, a reality capture of a light source 910 lighting a table 920 (from the left side of the table 920) and a corresponding shadow 922 can be captured and added to a multidimensional scene understanding (e.g., in a corresponding multidimensional scene set for the physical environment 900). Referring to FIG. 9B, a reality capture of a light source 930 lighting the table 920 (from behind the table 920) and a corresponding shadow 924 can be captured and added to the corresponding multidimensional scene set for the physical environment 900. The lighting of the physical environment 900 (e.g., light sources 910 and 930) can be indexed as a dimension of the corresponding multidimensional scene set.

After the reality captures illustrated in FIGS. 9A and 9B are performed and the corresponding multidimensional scene set for the physical environment 900 is created and modified, that multidimensional scene set can then be queried, where the query can specify (with appropriate syntax for the particular implementation) that the lighting dimension (e.g., light sources 910 and 930) be averaged. FIG. 9C illustrates a resulting visualization that can be provided in response to this query. For instance, as shown in FIG. 9C, the light source 910 and the light source 930 are shown in visualization, and shadows 922a and 924a (which are lighter than the respective shadows 922 and 924) are shown. In some implementations, this aggregation of light sources 910 and 930 in FIG. 9C can be accomplished by converting the images of FIGS. 9A and 9B from a pixel domain to a linear domain (e.g., using camera image metadata transforms), calculating a weighted sum (weighted average) based on the linear domain representation of the images of FIGS. 9A and 9B. Complimentary (e.g., reverse) transforms can then be used to convert the weighted sum image back to pixel domain, e.g., to produce the visualization shown in FIG. 9C.

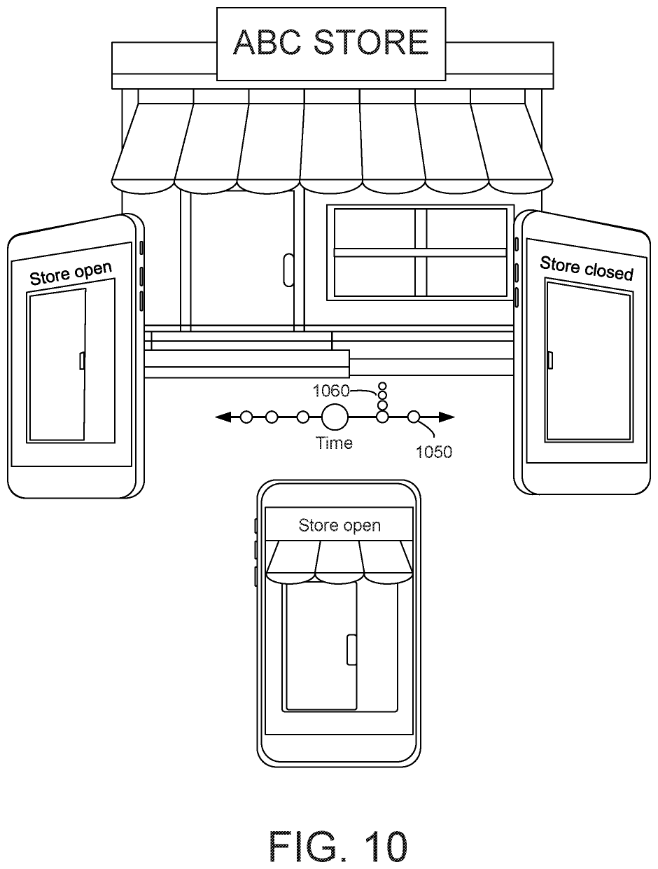

FIG. 10 is a diagram that illustrates usage of another multidimensional scene set. Specifically, FIG. 10 illustrates an example of querying a multidimensional scene set over time, in this case, to evaluate change in the status of a business (ABC Store 1010) in a physical environment 1000. FIG. 10 illustrates three reality captures 1020, 1030 and 1040 of the door of the store 1010 over time, which can be collected at a same time of day, on a same day of the week over a period of time (e.g., period of weeks or multiple weeks). The door of the store 1010, as well as time, can be indexed as dimensions of a corresponding multidimensional scene set for the physical environment 1000. As can be seen in the first two captures 1020 and 1030 shown in FIG. 10, the door indicates the store 1010 as being open, while in the third capture 1040, the door indicates the store 1010 as being closed, which could indicate the store 1010 is no longer in business. As also shown in FIG. 10, a visualization that is based on a query that specifies the door, the time of day and the day of the week dimensions can be provided. As shown in FIG. 10, a slider 1050 can be provided in the visualization of FIG. 10, which can be used to scroll through images corresponding with the query. The slider 1050 can also provide access to other available dimensions 1060 of the multidimensional scene set for the physical environment 1000.

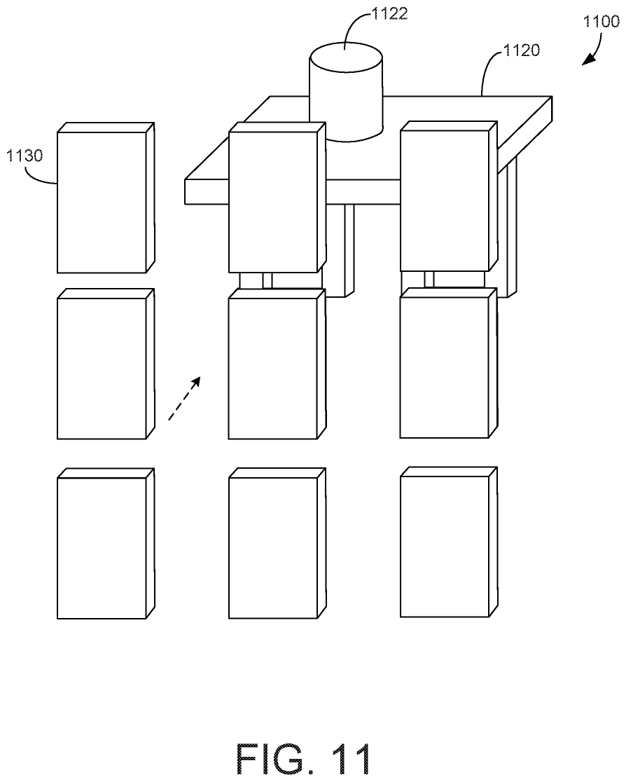

FIG. 11 is a diagram that illustrates generation of a multidimensional scene set using multiple reality captures, e.g., of an object 1122 on a table 1120. As illustrated in FIG. 11, multiple reality captures of the object 1122 can be collected by a capture device 1130, which can be a same capture device, or different capture devices. These multiple captures can be used to build a better real world understanding (create a better 3D model) of the object 1122, which can help increase the accuracy of visualization corresponding with queries on a corresponding multidimensional scene set for the physical environment 1100 that are indexed based on the object 1122.

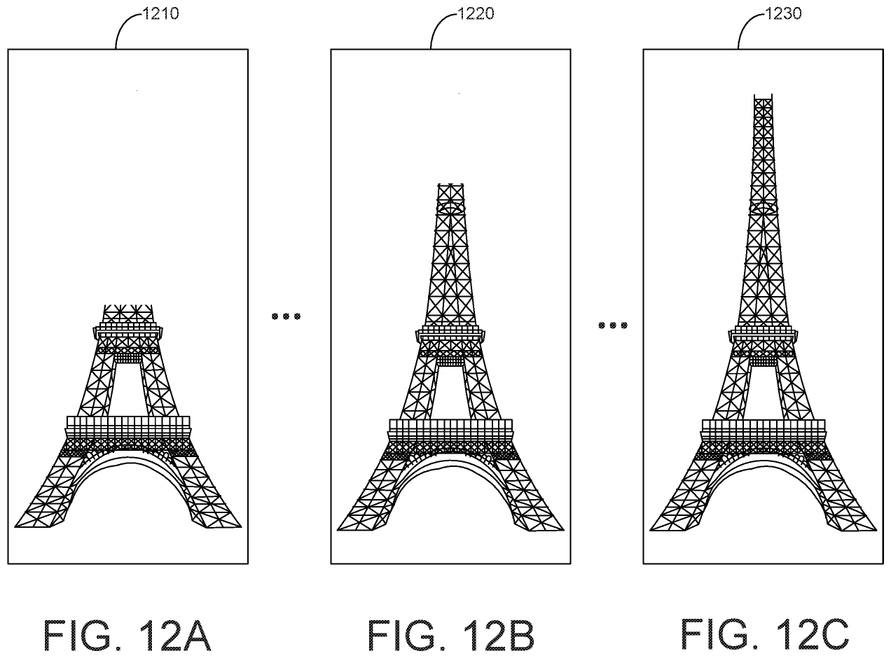

FIG. 12A-12C are a series of diagrams illustrate that generation of another multidimensional scene set. Specifically, FIGS. 12A-12C illustrates an example of creating a Specifically, FIGS. 12A-12C illustrate an example of creating a multidimensional scene set that includes changes in a structure over time, in this case, the Eiffel Tower. In this example, an image 1210 in FIG. 12A shows the tower at a first stage of construction, an image 1220 in FIG. 12B shows the tower at a second stage of construction, and an image 1230 in FIG. 12C shows the tower at a third stage of construction. In this example, reality captures of the tower at the various stages of construction shown in FIGS. 12A-12C could be performed, and the data from those reality captures aggregated in a corresponding multidimensional scene set. The tower (the changing structure) could be indexed as a dimension of the multidimensional scene set, and the changes (progress in construction) of the tower could be viewed (monitored) over time using an appropriate query on the corresponding multidimensional scene set. The results in response to that query could then be presented in a corresponding visualization.

In some implementations, such as those described herein, aggregation and interpolation of datasets can be performed to produce a 6-DOF light field representation. For example, utilizing multiple reality captures of an area of interest across perspectives in space and time (varying lighting conditions), a multidimensional dataset can be generated that can be used to determine, for a corresponding visualization pixels, image pose, coarse depth, refined geometry, surface and environment lighting estimates for generating explicit 3D meshes, or light field representations. For instance, light field representations, such as neural radiance fields, layered multi-depth map images that provide a 6DOF/multi-viewpoint representation that realistically represents reality can be provided.

In some implementations, based on such a light field representation, a corresponding multi-dimensional dataset can be queried to sample requested viewpoints (e.g., to find the right input views for synthesis) and corresponding geometric values (e.g., depth values, material values etc.) to produce an accurate light field representation. This could include determining an amount of overlap between corresponding views, an understanding of material properties of a corresponding scene, and/or a prior geometric representation that can be an input to the process. In such implementations, a large set of data can be sampled and then distilled down a set of input data for producing an associated light field representation.

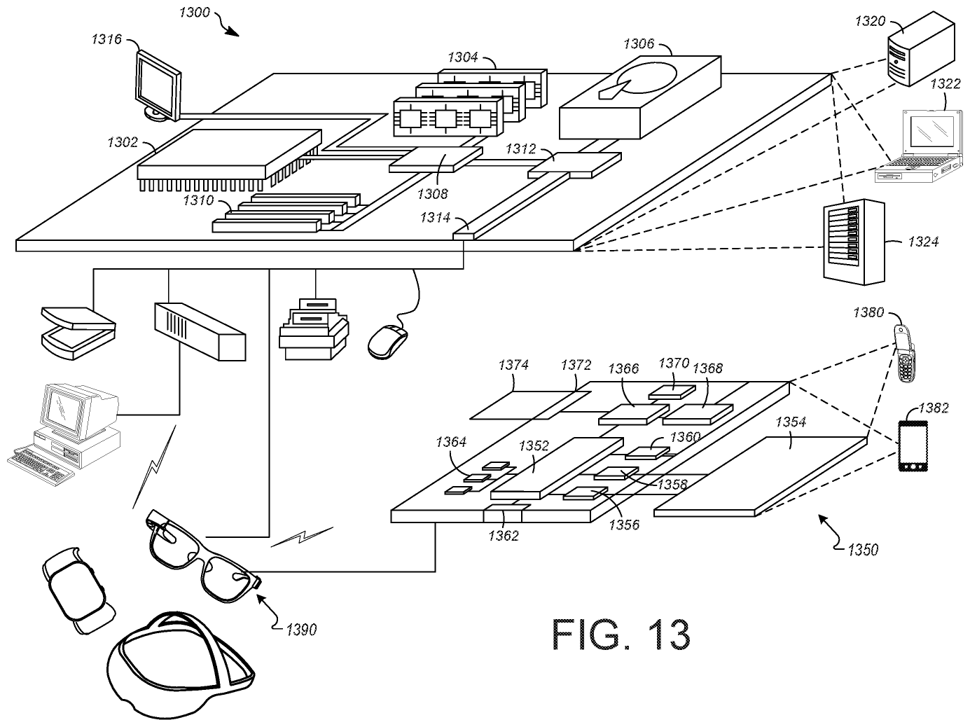

FIG. 13 illustrates an example of a computing device 1300 and a mobile computer device 1350, which may be used with the techniques described here, such as to provide client computing devices, server computing devices, and/or service provider resources configured to implement the approaches described herein. The computing device 1300 includes a processor 1302, memory 1304, a storage device 1306, a high-speed interface 1308 connecting to memory 1304 and high-speed expansion ports 1310, and a low-speed interface 1312 connecting to low-speed bus 1314 and storage device 1306. Each of the components 1302, 1304, 1306, 1308, 1310, and 1312, are interconnected using various busses, and may be mounted on a common motherboard or in other manners as appropriate. The processor 1302 can process instructions for execution within the computing device 1300, including instructions stored in the memory 1304 or on the storage device 1306 to display graphical information for a GUI on an external input/output device, such as display 1316 coupled to high-speed interface 1308. In other implementations, multiple processors and/or multiple buses may be used, as appropriate, along with multiple memories and types of memory. Also, multiple computing devices 1300 may be connected, with each device providing portions of the necessary operations (e.g., as a server bank, a group of blade servers, or a multi-processor system).

The memory 1304 stores information within the computing device 1300. In one implementation, the memory 1304 is a volatile memory unit or units. In another implementation, the memory 1304 is a non-volatile memory unit or units. The memory 1304 may also be another form of computer-readable medium, such as a magnetic or optical disk.

The storage device 1306 is capable of providing mass storage for the computing device 1300. In one implementation, the storage device 1306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1304, the storage device 1306, or memory on processor 1302.

The high-speed controller 1308 manages bandwidth-intensive operations for the computing device 1300, while the low-speed controller 1312 manages lower bandwidth-intensive operations. Such allocation of functions is example only. In one implementation, the high-speed controller 1308 is coupled to memory 1304, display 1316 (e.g., through a graphics processor or accelerator), and to high-speed expansion ports 1310, which may accept various expansion cards (not shown). In the implementation, low-speed controller 1312 is coupled to storage device 1306 and low-speed expansion port 1314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1300 may be implemented in a number of different forms, as shown in the figure. For example, it may be implemented as a standard server 1320, or multiple times in a group of such servers. It may also be implemented as part of a rack server system 1324. In addition, it may be implemented in a personal computer such as a laptop computer 1322. Alternatively, components from computing device 1300 may be combined with other components in a mobile device (not shown), such as device 1350. Each of such devices may contain one or more of computing device 1300, 1350, and an entire system may be made up of multiple computing devices 1300, 1350 communicating with each other.

Computing device 1350 includes a processor 1352, memory 1364, an input/output device such as a display 1354, a communication interface 1366, and a transceiver 1368, among other components. The device 1350 may also be provided with a storage device, such as a microdrive or other device, to provide additional storage. Each of the components 1350, 1352, 1364, 1354, 1366, and 1368, are interconnected using various buses, and several of the components may be mounted on a common motherboard or in other manners as appropriate.

The processor 1352 can execute instructions within the computing device 1350, including instructions stored in the memory 1364. The processor may be implemented as a chipset of chips that include separate and multiple analog and digital processors. The processor may provide, for example, for coordination of the other components of the device 1350, such as control of user interfaces, applications run by device 1350, and wireless communication by device 1350.

Processor 1352 may communicate with a user through control interface 1358 and display interface 1356 coupled to a display 1354. The display 1354 may be, for example, a TFT LCD (Thin-Film-Transistor Liquid Crystal Display), and LED (Light Emitting Diode) or an OLED (Organic Light Emitting Diode) display, or other appropriate display technology. The display interface 1356 may include appropriate circuitry for driving the display 1354 to present graphical and other information to a user. The control interface 1358 may receive commands from a user and convert them for submission to the processor 1352. In addition, an external interface 1362 may be provided in communication with processor 1352, so as to enable near area communication of device 1350 with other devices. External interface 1362 may provide, for example, for wired communication in some implementations, or for wireless communication in other implementations, and multiple interfaces may also be used.

The memory 1364 stores information within the computing device 1350. The memory 1364 can be implemented as one or more of a computer-readable medium or media, a volatile memory unit or units, or a non-volatile memory unit or units. Expansion memory 1374 may also be provided and connected to device 1350 through expansion interface 1372, which may include, for example, a SIMM (Single In-Line Memory Module) card interface. Such expansion memory 1374 may provide extra storage space for device 1350, or may also store applications or other information for device 1350. Specifically, expansion memory 1374 may include instructions to carry out or supplement the processes described above, and may include secure information also. Thus, for example, expansion memory 1374 may be provided as a security module for device 1350, and may be programmed with instructions that permit secure use of device 1350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1364, expansion memory 1374, or memory on processor 1352, that may be received, for example, over transceiver 1368 or external interface 1362.

Device 1350 may communicate wirelessly through communication interface 1366, which may include digital signal processing circuitry where necessary. Communication interface 1366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1368. In addition, short-range communication may occur, such as using a Bluetooth, Wi-Fi, or other such transceiver (not shown). In addition, GPS (Global Positioning System) receiver module 1370 may provide additional navigation- and location-related wireless data to device 1350, which may be used as appropriate by applications running on device 1350.

Device 1350 may also communicate audibly using audio codec 1360, which may receive spoken information from a user and convert it to usable digital information. Audio codec 1360 may likewise generate audible sound for a user, such as through a speaker, e.g., in a handset of device 1350. Such sound may include sound from voice telephone calls, may include recorded sound (e.g., voice messages, music files, etc.) and may also include sound generated by applications operating on device 1350.

The computing device 1350 may be implemented in a number of different forms, as shown in the figure. For example, it may be implemented as a cellular telephone 1380. It may also be implemented as part of a smartphone 1382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in FIG. 13 can include sensors that interface with an AR headset/HMD device 1390 to generate an augmented environment for viewing inserted content within the physical space. For example, one or more sensors included on a computing device 1350 or other computing device depicted in FIG. 13, can provide input to the AR headset 1390 or in general, provide input to an AR space. The sensors can include, but are not limited to, a touchscreen, accelerometers, gyroscopes, pressure sensors, biometric sensors, temperature sensors, humidity sensors, and ambient light sensors. The computing device 1350 can use the sensors to determine an absolute position and/or a detected rotation of the computing device in the AR space that can then be used as input to the AR space. For example, the computing device 1350 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device 1350 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 1350 when the computing device is incorporated into the AR space can cause a particular action to occur in the AR space.

In some implementations, a touchscreen of the computing device 1350 can be rendered as a touchpad in AR space. A user can interact with the touchscreen of the computing device 1350. The interactions are rendered, in AR headset 1390 for example, as movements on the rendered touchpad in the AR space. The rendered movements can control virtual objects in the AR space.

In some implementations, one or more output devices included on the computing device 1350 can provide output and/or feedback to a user of the AR headset 1390 in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 1350 may appear as another object in a computer-generated, 3D environment. Interactions by the user with the computing device 1350 (e.g., rotating, shaking, touching a touchscreen, swiping a finger across a touch screen) can be interpreted as interactions with the object in the AR space. In the example of the laser pointer in an AR space, the computing device 1350 appears as a virtual laser pointer in the computer-generated, 3D environment. As the user manipulates the computing device 1350, the user in the AR space sees movement of the laser pointer. The user receives feedback from interactions with the computing device 1350 in the AR environment on the computing device 1350 or on the AR headset 1390. The user's interactions with the computing device may be translated to interactions with a user interface generated in the AR environment for a controllable device.

In some implementations, a computing device 1350 may include a touchscreen. For example, a user can interact with the touchscreen to interact with a user interface for a controllable device. For example, the touchscreen may include user interface elements such as sliders that can control properties of the controllable device.

Computing device 1300 is intended to represent various forms of digital computers and devices, including, but not limited to laptops, desktops, workstations, personal digital assistants, servers, blade servers, mainframes, and other appropriate computers. Computing device 1350 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A computer-implemented method, comprising:
capturing, by one or more of a plurality of sensors of a computing device, respective sensor data corresponding to a physical environment;
generating, by a processor of the computing device from the respective sensor data, a multidimensional dataset representative of the physical environment, the multidimensional dataset including:
the respective sensor data;
geometric data corresponding with the physical environment; and
semantic data corresponding with the physical environment; and
identifying and indexing, by the processor of the computing device, a plurality of dimensions of the multidimensional dataset, such that the plurality of dimensions of the multidimensional dataset can be, at least one of, searched, queried, and/or modified to provide, based on the search, query and/or modification, a visualization of the physical environment on a display device.

2. The method of claim 1, wherein:
the geometric data is derived from the respective sensor data, and
the semantic data is determined from the geometric data and the respective sensor data.

3. The method of claim 2, wherein the semantic data is further determined based on features of the physical environment identified by an augmented reality (AR) framework.

4. The method of claim 3, wherein the AR framework is implemented by one of the processor of the computing device, or a computing device operatively coupled with the computing device.

5. The method of claim 1, wherein the respective sensor data is first sensor data, the method further comprising:
capturing second sensor data corresponding to the physical environment; and
modifying, based on the second sensor data, the multidimensional dataset.

6. The method of claim 5, wherein capturing the second sensor data includes providing capturing guidance, via the computing device, the capturing guidance being based on the multidimensional dataset.

7. The method of claim 5, wherein the geometric data is first geometric data, and the sematic data is first semantic data, the modifying the multidimensional dataset including:
adding the second sensor data to the multidimensional dataset;
adding second geometric data corresponding with the physical environment to the multidimensional dataset; and
adding second semantic data corresponding with the physical environment to the multidimensional dataset.

8. The method of claim 7, wherein modifying the multidimensional dataset further includes at least one of:
determining differences between the first sensor data and the second sensor data;
determining differences between the first geometric data and the second geometric data; or
determining differences between the first semantic data and the second semantic data.

9. The method of claim 5, wherein the modifying the multidimensional dataset includes:
aggregating the second sensor data with the first sensor data to produce aggregated sensor data;
modifying the geometric data based on the aggregated sensor data; and
modifying the semantic data based on the aggregated sensor data and the modified geometric data.

10. The method of claim 5, wherein the capturing the second sensor data includes capturing the second sensor data with one or more of the plurality of sensors of the computing device.

11. The method of claim 5, wherein,
the computing device is a first computing device; and
the capturing the second sensor data includes capturing respective sensor data for a plurality of sensors of a second computing device.

12. The method of claim 1, wherein the plurality of dimensions include one or more of:
lighting of the physical environment;
objects in the physical environment;
a time corresponding with capturing the respective sensor data;
regions of the physical environment;
physical dimensions of the physical environment; or
surfaces in the physical environment.

13. The method of claim 1, wherein the plurality of sensors include one or more of:
an image sensor;
a depth sensor;
a location sensor;
an orientation sensor;
a motion sensor;
a light sensor;
a pressure sensor; or
a temperature sensor.

14. The method of claim 1, further comprising:
receiving, at the computing device or another computing device, a visualization request including a query identifying a dimension of the plurality of dimensions of the multidimensional dataset; and
providing, on a display device of the computing device or the other computing device, a visualization based on the multidimensional dataset and the query.

15. A computing device comprising:
a plurality of sensors;
a processor; and
a memory having instructions stored thereon, the instructions, when executed by the processor, result in:
capturing, by one or more of the plurality of sensors of the computing device, respective sensor data corresponding to a physical environment;
generating, by the processor of the computing device from the respective sensor data, a multidimensional dataset representative of the physical environment, the multidimensional dataset including:
the respective sensor data;
geometric data corresponding with the physical environment; and
semantic data corresponding with the physical environment; and
identifying and indexing, by the processor of the computing device, a plurality of dimensions of the multidimensional dataset, such that the plurality of dimensions of the multidimensional dataset can be, at least one of, searched, queried, and/or modified to provide, based on the search, query and/or modification, a visualization of the physical environment on a display device.

16. The computing device of claim 15, wherein the respective sensor data is first sensor data, the instructions, when executed by the processor, further result in:
capturing second sensor data corresponding to the physical environment; and
modifying, based on the second sensor data, the multidimensional dataset.

17. The computing device of claim 16, wherein capturing the second sensor data includes providing capturing guidance, via the computing device, the capturing guidance being based on the multidimensional dataset.

18. A non-transitory computer-readable medium having instructions stored thereon, the instructions, when executed by a processor of a computing device, resulting in the computing device:
capturing, by one or more of a plurality of sensors of a computing device, respective sensor data corresponding to a physical environment;
generating, from the respective sensor data, a multidimensional dataset representative of the physical environment, the multidimensional dataset including:
the respective sensor data;
geometric data corresponding with the physical environment; and
semantic data corresponding with the physical environment; and
identifying and indexing a plurality of dimensions of the multidimensional dataset, such that the plurality of dimensions of the multidimensional dataset can be, at least one of, searched, queried, and/or modified to provide, based on the search, query and/or modification, a visualization of the physical environment on a display device.

19. The non-transitory computer-readable medium of claim 18, wherein the respective sensor data is first sensor data, the instructions, when executed by the processor, further result in the computing device:
capturing second sensor data corresponding to the physical environment; and
modifying, based on the second sensor data, the multidimensional dataset.

20. The non-transitory computer-readable medium of claim 18, wherein the instructions, when executed by the processor, further result in the computing device:
receiving, at the computing device or another computing device, a visualization request including a query identifying a dimension of the plurality of dimensions of the multidimensional dataset; and
providing, on a display device of the computing device or the other computing device, a visualization based on the multidimensional dataset and the query.
